(19) United States
(12) Patent Application Publication
(10) Pub. No.: US 2007/0208482 A1
(43) Pub. Date: Sep. 6, 2007

(54) INTELLIGENT BRAKING SYSTEM AND METHOD

(75) Inventors: DAVID THIEDE, Eden Prairie, MN (US); Jon P. Beatty, Minnetonka, MN (US); Richard A. Gunderson, Eden Prairie, MN (US); John R. McKinley, Kansas City, MO (US)

Correspondence Address: Schwegman, Lundberg, Woessner & Kluth, P.A., P.O. Box 2938, Minneapolis, MN, 55402, US

(73) Assignee: Altra Technologies Incorporated

(21) Appl. No.: 11/747,494

(22) Filed: May 11, 2007

Related U.S. Application Data
(63) Continuation of application No. 11/237,386, filed on Sep. 28, 2005.
Application No. 11/237,386 is a continuation of application No. 10/021,902, filed on Dec. 17, 2001, now abandoned.

(51) Int. Cl. G06G 7/78

(52) U.S. Cl. 701/70

(57) ABSTRACT

A distance, speed and direction sensitive processor coupled to a brake controller. The processor executes instructions to compare actual vehicle performance with that of a deceleration profile and modulates the brake controller to bring vehicle performance into agreement with the profile. Distance information is provided by a radar sensor for long ranges, an ultrasonic sensor for medium ranges, and a wheel rotation sensor for short ranges. Speed information is provided by a vehicle mounted sensor or calculated by the processor based on distance. Direction information is provided by a vehicle mounted switch or determined by the processor based on distance. The brake controller includes a hold valve and a dump valve, each of which is modulated with a pulse train signal.

This application is a continuation of U.S. application Ser. No. 11/237,386, filed on Sep. 28, 2005, which is a continuation of U.S. application Ser. No. 10/021,902, filed on Dec. 17, 2001, both of which are incorporated herein by reference.

### TECHNICAL FIELD

This document relates generally to the field of vehicle braking systems, devices and methods and particularly, but not by way of limitation, to systems and methods for applying brakes on a trailer or other vehicle.

### BACKGROUND

Accidents in the motor vehicle industry are sometimes caused by maneuvering the vehicle in a direction of poor visibility. The rear of a semi-trailer, truck, or motorhome presents one such example of a blind spot. Often, drivers of large vehicles have limited or no visibility to areas directly behind the vehicle. When backing up to a loading dock, for example, the driver may rely on the visual perception of distance while looking through side view mirrors. Drivers and owners of commercial fleets often report that side view mirrors are inadequate. This is consistent with damage to loading docks, damage to the rear of the vehicle, and other accidents that occur while the vehicle is backing up.

Accidents and property losses are typical outcomes when drivers are unaware of hazards behind the vehicle or lack adequate information concerning objects at the rear of the vehicle.

Previous efforts to assist the driver have not provided a complete solution to this problem. For example, some efforts have included mirrors directed to the rear of the vehicle or video cameras mounted at the rear of the vehicle in an effort to provide data to the driver. Generally, mirrors and video cameras have proven inadequate because they rely on good lighting conditions and are incapable of automatically warning the driver of hazardous conditions. Furthermore, drivers are sometimes distracted and are unaware of hazards that may appear in a mirror or video monitor. In sum, technologies that rely on driver awareness, judgment, and action often result in accidents while backing up.

What is needed is a system and method that allows a driver to safely operate a vehicle in a low speed situation and is impervious to driver inattention or poor judgement.

### SUMMARY

The present subject matter provides an intelligent braking system that controls the rate of deceleration of the vehicle according to a predetermined deceleration profile. The vehicle speed is controlled by modulating a brake system based on system inputs including, among other things, vehicle speed, direction and distance to obstacle.

Various embodiments of the present system include distance measuring equipment, vehicle direction sensor, vehicle speed sensor, vehicle condition sensors and brake control circuitry coupled to a processor. The distance measuring equipment includes one sensor such as radar, laser, ladar, or ultrasonic device. The vehicle direction sensor and speed sensor inform the processor whether the vehicle is standing still, moving in reverse, or moving forward and, if moving, the speed of the vehicle. The vehicle condition sensors provide information concerning factors such as the position of doors on the vehicle, valve position or hydraulic lift position. The brake controller includes the drive circuitry, solenoids and/or valves to allow the processor to automatically apply the brakes, to adjust the pressure applied during the braking function, or to automatically release the brakes. The brake controller may operate with hydraulic, pneumatic, or electronic brake systems as well as systems having antilock brakes.

In one embodiment, the system includes a processor to control vehicle braking. The processor receives data concerning vehicle speed and direction and range data to an object as well as vehicle condition sensor inputs. The processor executes instructions and compares the vehicle status with a deceleration profile and controls the brakes accordingly. In one embodiment, the vehicle brakes are applied to gradually slow the vehicle for purposes of parking at a loading dock. In one embodiment, the brakes are applied rapidly if sensors indicate an emergency stop is warranted. An emergency stop may be executed if a person, car, or other object suddenly appears behind the vehicle while backing up. In one embodiment, the vehicle brakes are applied to restrict the forward movement, rearward movement, or both forward and rearward movement of the vehicle.

One embodiment includes a pair of ultrasonic sensors flanking a center mounted radar sensor. The hybrid system of ultrasonic and radar technology provides a level of redundancy that improves system reliability in the event of partial failure. In one embodiment, the three sensors are directed rearward and provide distance information in the range of approximately one to 15 feet. A Hall effect sensor coupled to a wheel of the vehicle provides vehicle speed and direction information. A processor coupled to each of the sensors executes a set of instructions to compare the actual vehicle speed, position and direction with that of a target deceleration profile. The deceleration profile may assist a driver in parking a vehicle in a particular location, such as a loading dock or other structure. Based on the outcome of the comparison, the processor provides a signal to a brake controller to modulate the speed of the vehicle, and therefore, safely control the approach to the object (e.g. loading dock, trash container) behind the vehicle. The brake controller, in one embodiment, includes a dump valve and a hold valve, each of which are operated according to a train of electronic pulses.

In one embodiment, the present subject matter is effective to limit both forward and rearward movement of the vehicle. For example, if, while the vehicle is stopped, a door on the box or trailer is in an open position, or if a particular valve is left in an open position, or if a hydraulic lift remains in an unsafe position, then one embodiment of the present subject matter prevents movement of the vehicle in the forward or reverse direction. The present subject matter provides a warning to the driver and automatically restricts the movement of the vehicle.

In one embodiment, a sensor provides information relative to the condition of the vehicle. For example, a sensor is adapted to monitor the position of a fluid dispensing valve on a tanker truck. If while stopped, the sensor indicates that the valve is in an open position, then the present system may prevent movement of the vehicle by applying and holding the vehicle brakes. Other sensors are also contemplated, such as, for example, door position sensors, fluid level sensors or other sensors that monitor conditions that may endanger the vehicle, personal property, the driver or others. In one embodiment, the sensor signal prevents movement of the vehicle in a forward direction, a rearward direction or any direction.

Other aspects of the present subject matter will be apparent on reading the following detailed description of the invention and viewing the drawings that form a part thereof.

### BRIEF DESCRIPTION OF THE DRAWINGS

In the drawings, like numerals describe substantially similar components throughout the several views. Like numerals having different letter suffixes represent different instances of substantially similar components.

FIG. 1 illustrates a side view of a vehicle near a loading dock.

FIG. 2 depicts a graph of speed versus distance for a particular embodiment of the present subject matter.

FIG. 3 is a schematic of one embodiment of the present system.

FIG. 4 is a schematic of an embodiment having a plurality of sensors and a brake controller having a dump valve and a hold valve.

FIG. 5 illustrates a side view of a vehicle near a loading dock according to one embodiment of the present system.

FIG. 6 illustrates a rear view of a vehicle according to one embodiment of the present system.

FIG. 7 illustrates sensors in a side view of a vehicle near a loading dock.

FIG. 8 illustrates a speed sensor according to one embodiment of the present system.

FIG. 9 illustrates a display of a computer executing a program according to one embodiment of the present subject matter.

FIG. 10 illustrates a state diagram according to one embodiment of the present subject matter.

FIGS. 11A, B and C illustrate a flow chart according to one embodiment of the present subject matter.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be taken in a limiting sense, and the scope of the present invention is defined by the appended claims and their equivalents.

In this document, the term “vehicle” refers to any land-based motorized vehicle or trailer equipped with a braking mechanism.

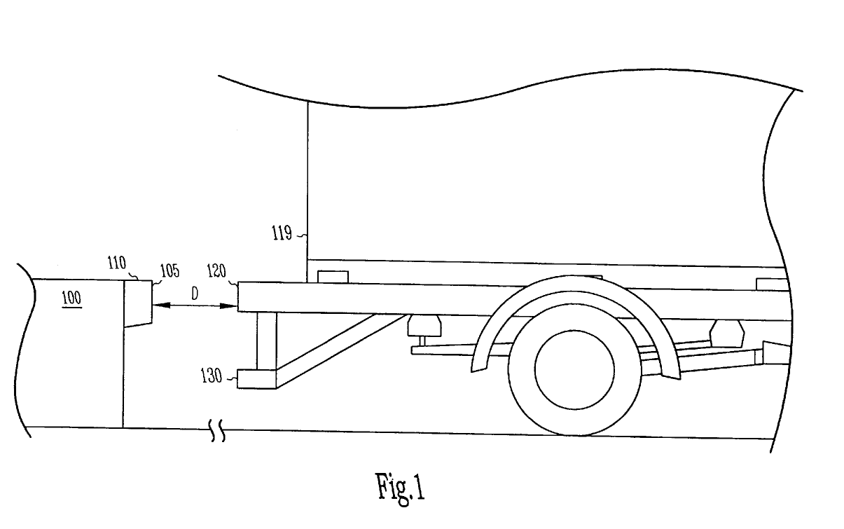

FIG. 1 depicts vehicle 119 separated from loading dock 100 by distance D. In the figure, the vehicle depicts a truck or a trailer portion of a semi-tractor/trailer rig. Upper bumper surface 120 is aligned to contact surface 105 of dock bumper 110 affixed to dock 100. Typically, dock 100 includes a poured concrete structure and dock bumper 110 made of rubber or a wood product.

The dock structure is virtually immobile. The energy of a low velocity impact is largely absorbed by dock bumper 110 with no resultant damage. Medium velocity impacts may damage portions of vehicle 119, including upper bumper surface 120 and lower bumper surface 130. High energy impacts with dock 100 may result in damage to vehicle 119 as well as dock 100.

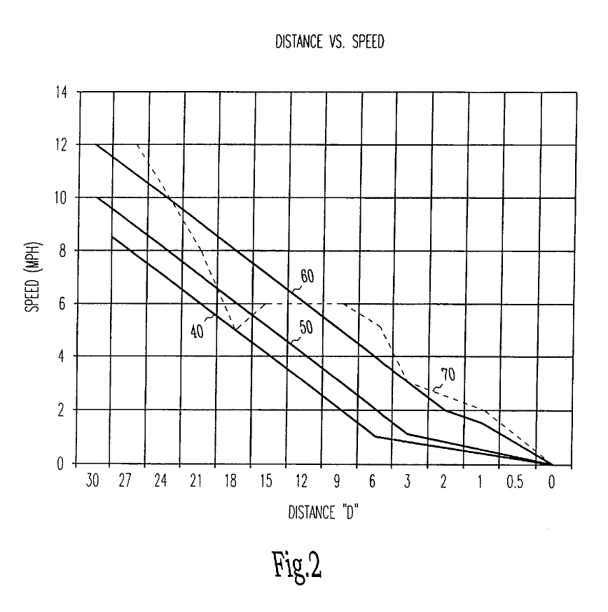

FIG. 2 illustrates a graph of distance D versus vehicle speed operable with the present system. The graph depicts ideal deceleration profile 50, minimum profile 40, maximum profile 60 and sample profile 70. The data represented in the figure is encoded as a mathematical function or look-up table accessible to a processor of the present system. The figure shows that the vehicle speed decreases when approaching the target distance. The target distance may be zero to several inches away from the surface of the loading dock.

When the processor determines that the speed, distance, and direction are such that the maximum profile 60 has been exceeded, the processor activates the brake controller to slow the vehicle. Vehicle performance below minimum profile 40 is allowed to proceed until the vehicle has entered the window.

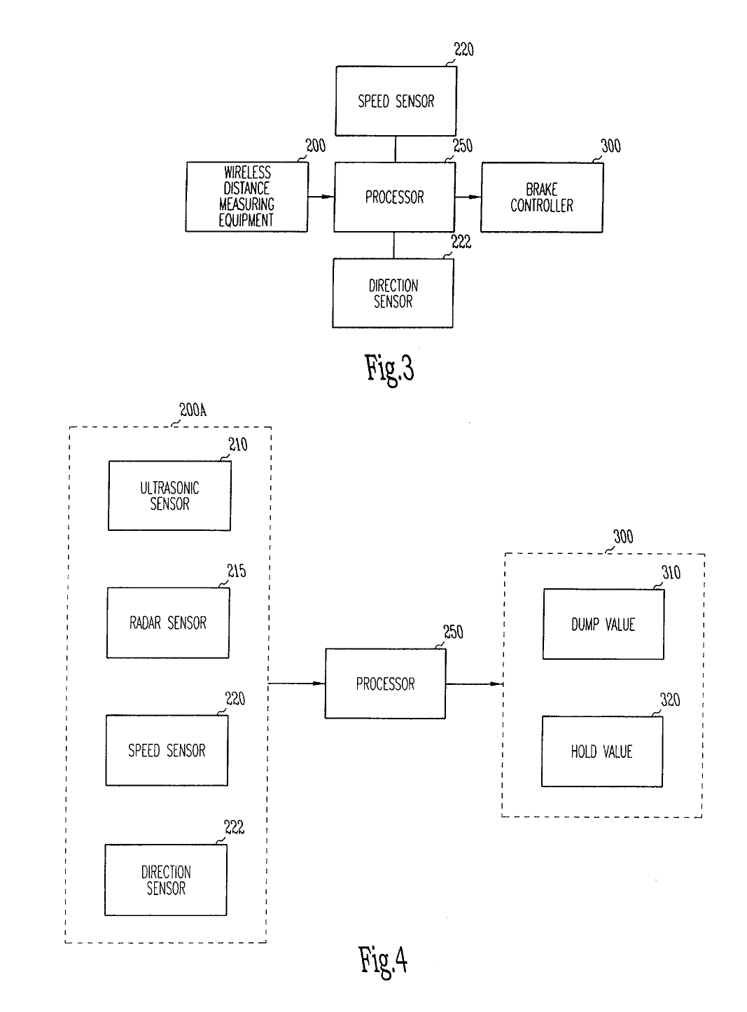

FIG. 3 depicts a block diagram of the present system. Processor 250 receives data from wireless distance measuring equipment 200 as well as speed sensor 220 and director sensor 222 and provides an output signal to brake controller 300.

In various embodiments, distance measuring equipment 200 includes a wired or wireless sensor. The sensor may include one or more sensors including technologies such as radar, laser, ladar, infrared, video or ultrasonic. In one embodiment, the sensor provides a signal corresponding to a distance to an obstacle.

In one embodiment, the wireless distance measuring equipment includes a combination of radar and ultrasonic detectors. In one embodiment, vehicle speed data is received from a wheel rotation sensor. Other sensors may also be used, such as, for example, a sensor driven by the vehicle transmission or differential, a global positioning sensor, or other such sensors.

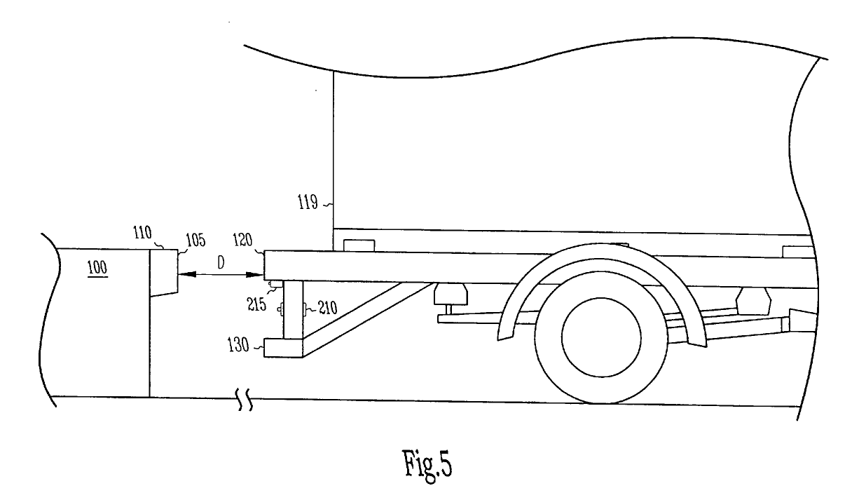

FIG. 4 illustrates one embodiment including distance measuring equipment 200A having ultrasonic sensor 210, radar sensor 215, speed sensor 220 and direction sensor 222 coupled to processor 250. Processor 250 is coupled to dump valve 310 and hold valve 320 of brake controller 300.

In the figure, radar sensor 215 provides a signal for objects detected within a range of approximately 20 to 50 feet. Ultrasonic sensor 210 provides a reliable signal in the range of approximately 12 inches to 20 feet and distances below approximately 12″ are determined by processor 250 based on data from speed sensor 220.

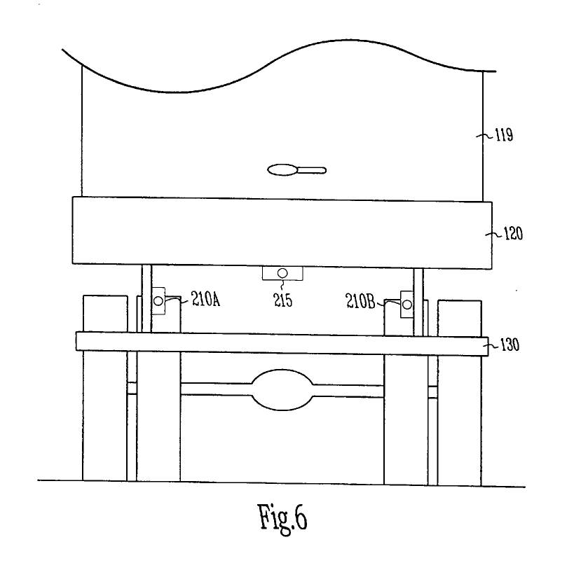

FIG. 5 illustrates a side view of vehicle 119 with ultrasonic sensor 210 and radar sensor 215 visible. Ultrasonic sensor 210 is affixed to a vertical portion supporting lower bumper 130 and radar sensor 215 is affixed adjacent to upper bumper surface 120. In one embodiment, more than one radar sensor or more than one ultrasonic sensors are used.

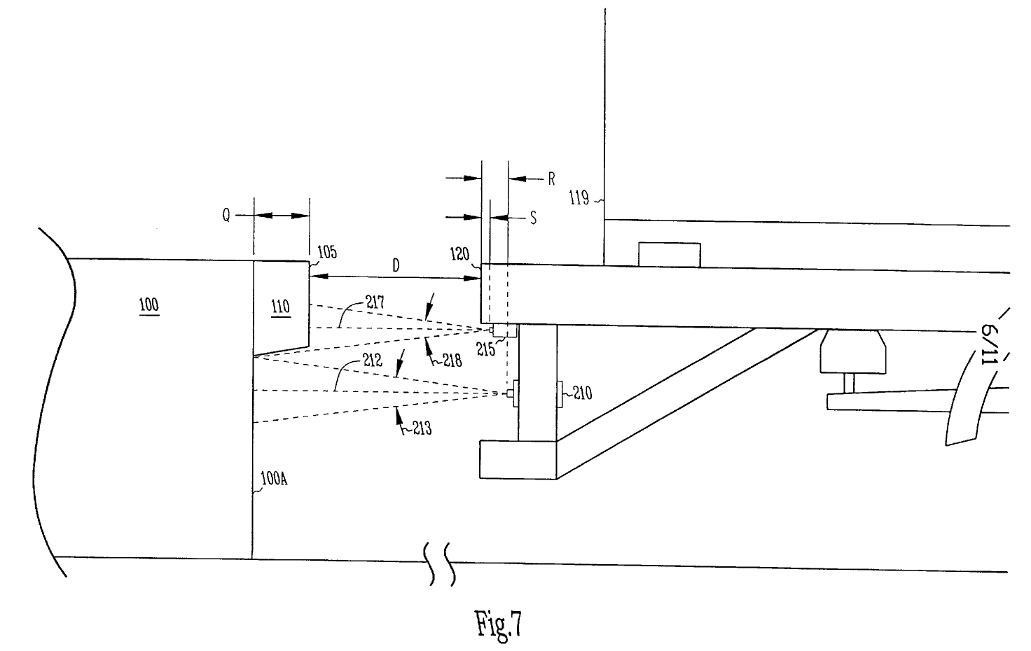

FIG. 6 illustrates a rear view of vehicle 119 with ultrasonic sensors 210A and 210B. The symmetrical arrangement of ultrasonic sensors 210A and 210B may provide additional accuracy. Data from sensors 210A and 210B is processed by processor 250 and a weighting, or averaging, function may be executed to derive reliable data as to distance D. Sensors 210A, 210B and 215 are directed to project a detection signal substantially rearward of the vehicle.

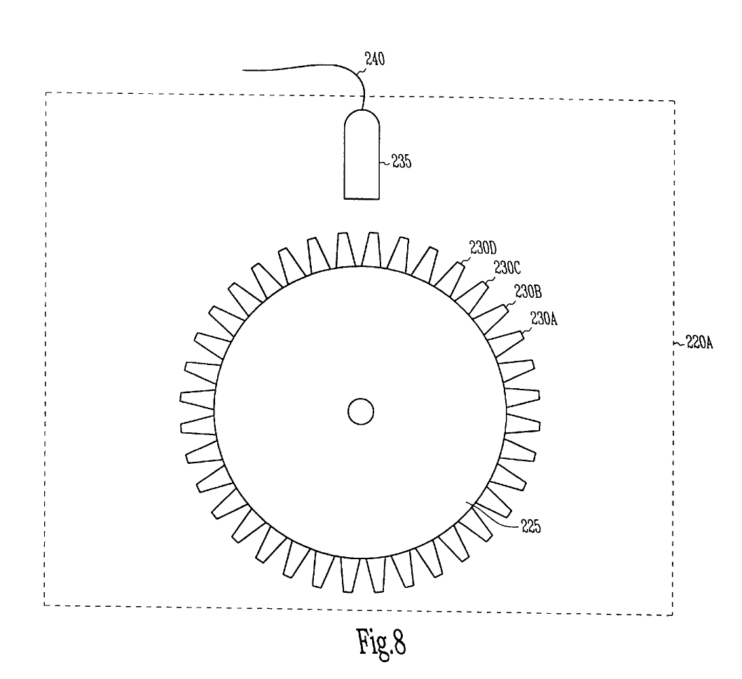

FIG. 7 illustrates a view of vehicle 119, with sensors 215 and 210, and dock 100. Dock bumper surface 105 projects forward of dock 100 by distance Q. In addition, radar sensor 215 is displaced forward of upper bumper surface 120 by distance S and ultrasonic sensor 210 is displaced forward by distance R. Distances R and S are offsets established by the configuration of vehicle 119, the respective sensors, and the mounting thereof. Processor 250 executes programming based on the offsets of distances R and S, thus yielding accurate determination of distance D.

The offset denoted by distance Q is accommodated by any of several methods. For example, in one embodiment, the driver makes a visual estimate and stores a value in a memory accessible to processor 250. In one embodiment, distance Q is determined by a comparison of signals from sensor 215 and sensor 210. In the figure, sensor 215 projects a beam centered on axis 217 and generates a signal based on reflections within a narrow cone defined by zone 218. Sensor 210 projects a beam centered on axis 212 and generates a signal based on reflections within a narrow cone defined by zone 213. Suitable programming executing on processor 250 includes masking functions to filter data outside of zone 218 and zone 213 and allows processor 250 to determine a distance Q. In one embodiment, distance Q is a predetermined dimension.

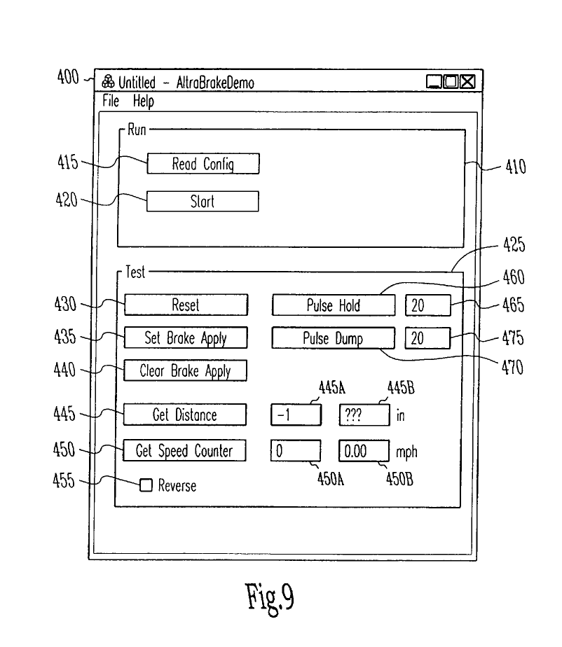

FIG. 8 illustrates speed sensor 220A according to one embodiment of the present subject matter. Metal toothed sprocket 225 is driven at a speed based on vehicle wheel rotation. For example, in one embodiment, sprocket 225 is coupled directly to a wheel spindle and rotates on a common shaft. The circumference of sprocket 225 includes a plurality of teeth, some of which are labeled in the figure as 230A, 230B, 230C and 230D. Hall effect sensor 235 is positioned near the teeth of sprocket 225. Line 240 carries a signal generated by sensor 235 based on a magnetic field around sprocket 225. Hall effect 235 sensor generates a pulse based on the passage of a nearby tooth. In one embodiment, sensor 220A provides a signal relative to both the direction and speed of rotation of sprocket 225, and hence vehicle 119.

### Exemplary Embodiment

The following section describes one embodiment of the present system.

One embodiment includes a pair of ultrasonic sensors affixed to the rear of a vehicle. The ultrasonic sensors are aligned to direct a signal to the rear of the vehicle. The ultrasonic sensor is coupled to a processor by a serial RS-485 cable. The system also includes a Hall effect speed and direction sensor affixed to one wheel of the vehicle. The Hall effect sensor is connected to the processor by an interface circuit and a National Instruments PCMCIA DAQ board model 623E.

The parameters that drive the brake controller are stored as text in a Windows INI file. The text format of this file facilitates changes. The text file includes values for the HOLD pulse width and DUMP pulse width, target distance to dock (for success), serial port configuration data and a deceleration profile. The deceleration profile includes a series of minimum and maximum speed values as a function of distance. The number of entries in the deceleration profile corresponds to entries in the INI file.

Upon running the software, the INI file is initially read and the DAQ board is configured. A software re-load button is provided and upon activation, the processor re-reads the INI file, re-configures the serial port configuration data and re-loads the deceleration profile. The re-load button is normally used after the user has manually entered changes to the INI file.

The processor receives direction information from the Hall effect sensor and after determining that the vehicle is traveling rearward, and that the speed is greater than zero, the BRAKE-APPLY line and HOLD line are raised.

The processor then compares data from the deceleration profile with measured distance and speed information from the vehicle. If the vehicle speed exceeds the maximum speed, at any particular distance, then the brakes are applied. The brake pressure is stepped up based on the software sampling rate until the vehicle speed is within the maximum and minimum speed values.

The vehicle brakes are not released when the speed is within the bounds of the deceleration profile. If the vehicle speed falls below the minimum speed, then the brakes are released by pulsing the DUMP line. The brakes are released in steps until the vehicle returns to within the minimum profile 40 and the maximum profile 60 of the deceleration profile. The process of cycling the brake controller terminates when the vehicle is within the min/max limits of the deceleration profile.

Distance data, for ranges from the dock greater than approximately 15″, is derived from the ultrasonic sensor. The speed sensor provides distance data below approximately 15″. At distances below approximately 15″ the processor drops the ultrasonic sensor distance data and relies on the speed sensor.

Within approximately 15″, the processor calculates distance based on the last accurate distance information provided by the ultrasonic sensor with an adjustment provided by the speed sensor. The processor continues to operate the brake system in the manner described above until the vehicle has reached the target distance to dock. At the target distance, the processor applies the brakes for an uninterrupted period of time. The uninterrupted period of time is adjustable and in one example, the value is one second.

Other parameters of this system are also adjustable. For example, the sampling rate for the processor is user selectable, thus allowing changes to the brake pulse rate.

The brake air pressure is capable of rising more rapidly than falling (venting), and thus, the sampling rate has four components that control the operation of the brake solenoids. The four components are the HOLD pulse width value, the DUMP pulse width value, and the HOLD cycle value and the DUMP cycle value.

Consider the following parking example, illustrated in FIG. 2. Assume that the direction signal is indicating rearward travel and at a distance of 10′ from the dock, the processor directs the brake controller to apply the brakes because the speed exceeds the maximum profile 60 at that distance. Since the processor knows the vehicle is moving rearward, the BRAKE-APPLY and BRAKE-HOLD lines are raised to a logical high. The BRAKE-APPLY line will remain high for the duration of the braking or until the vehicle has stopped. The BRAKE-HOLD line will be pulsed, or lowered and rapidly raised to step up the brake pressure. Lowering the BRAKE-HOLD line causes the brake controller to energize the HOLD solenoid for the programmable HOLD pulse width value.

After the software HOLD pulse width delay (stored in the INI file), the processor again samples the speed and distance.

Assume now the vehicle is at 9′ from the dock and the brakes are to be applied again. The HOLD line is lowered and rapidly raised which will cause the brake actuator to again energize the HOLD solenoid for the programmed amount of time, thus stepping up the brake pressure.

Assume at the next sampling by the processor, the vehicle is 8′ from the dock. Now the speed is within the deceleration profile so the HOLD line remains high, thus the brake pressure will continue and the vehicle will decelerate. This condition continues until the sample at the 6′ position. Here, the speed has dropped below the deceleration profile so the brake pressure is dropped by maintaining the HOLD line at high and raising the DUMP line. This causes the brake controller to energize the DUMP solenoid for the programmable DUMP pulse width time, thus bleeding pressure from the brake system. The process of dumping pressure continues until the vehicle is again within the deceleration profile.

Assume now the vehicle is within approximately 15″ to 18″ of the dock. At this range, the ultrasonic sensor is no longer reliable and thus, speed pulses from the speed sensor are used to determine the distance traveled. The sensor provides 103,600 pulses per mile or approximately 1.6 pulses per inch.

This process continues until the vehicle attains the target distance. At the target distance, the brakes are held on for a programmable period of time followed by a release of brake pressure. Releasing includes lowering the BRAKE-APPLY line and raising the DUMP line for a maximum of 500 mS. The HOLD line is then lowered.

The HOLD line is raised before raising the BRAKE-APPLY line, thereby preventing depletion of the pressure from the air tank. In one embodiment, the maximum air pressure can be dumped to zero in approximately 500 mS using the DUMP controller. The time to dump the maximum air pressure can be used to determine the maximum number of DUMP pulses. For example, 500 milliseconds divided by the DUMP pulse width yields the maximum number of DUMP pulses. After reaching the maximum number of DUMP pulses, the HOLD line can be lowered. This assures that the vehicle will have brake capacity remaining after stopping short of the dock.

In one embodiment, each of the hold and dump systems includes a line, a solenoid and a valve. The line carries an electrical signal for controlling current in the solenoid. The solenoid is mechanically coupled to the valve.

In one embodiment, if the vehicle moves forward a small amount after successfully reaching the target dock distance, then distance data continues to be derived from the speed sensor provided that the vehicle has not entered the range of the ultrasonic sensor. If the vehicle has moved far enough for the data from the ultrasonic sensor to be reliable, then that data is used. In one embodiment, data from one or more other sensors provides distance data accurate down to 1 inch minimum measurable distance. In one embodiment having one or more other sensors, distance data is not derived from the speed sensor data. The other sensors may include a ladar based sensor or an infrared based sensor.

In one embodiment, the sampling rate of the processor exceeds the time required for the vehicle to move a distance of one foot, as described in the exemplary method. Thus, the processor checks the vehicle conditions more frequently than one foot increments.

In one embodiment, the direction data from the Hall effect sensor does not include a debounce mechanism. If the sensor is positioned on the edge of a tooth and the vehicle rocks slightly, the signal from the sensor can change. Software executing on the processor determines when the vehicle is moving rearward by waiting a delay period of time after first detecting that the vehicle is moving forward. The delay period of time is adjustable. The processor then flushes the brake system by executing multiple DUMP pulses followed by lowering of the BRAKE-APPLY line.

In one embodiment, a directional data sensor provides information to the processor as to the direction of travel of the vehicle. For example, the distance between the dock and the vehicle may exceed the range capabilities of the range sensor in which case direction data is derived from a sensor. In one embodiment, the direction sensor includes a Hall effect sensor.

The INI file includes four categories of parameters as follows:

Settings includes general software settings, Deceleration Profile includes distance, speed, and thread latency rates; Brake includes brake performance parameters including pulse widths and stop speeds; DAQ includes data acquisition card settings. Table 1 below includes Settings, Deceleration Profile, Brake and DAQ parameters for one embodiment of the present system.

Data in the Deceleration Profile category can be determined experimentally and data in all categories can be user selectable.

TABLE 1

| Configuration | | |
|---|---|---|
| Parameter | Default | Description |
| Settings | | |
| PulsesPerMile | 103600 | Number of speed sensor pulses per mile of travel |
| Ultrasonic Resolution | 1.66 | Number of sensor pulses per inch (default value |
| | | shown) |
| Ultrasonic Noise Count | 0 | Number of identical sensor readings in a row before |
| | | the current value is accepted. If 0, each new value |
| | | is accepted. For example, if noise count = 2 and |
| | | readings are 10, 10, 13, 12, 14, 14, then the |
| | | accepted values are 10 and 14. |
| ReverseMonitorLatency | 500 | How frequently, in ms, the software checks for |
| | | vehicle to be in reverse before entering docking |
| | | state machine. |
| BrakeThreadLatency | 100 | The default sampling period, in ms, during docking. |
| | | This value may be overridden by table entry thread |
| | | latencies. |
| PulseLatency | 10 | Number of ms a hold or dump signal is held active |
| | | before setting inactive. |
| StopLatency | 3000 | The amount of time to pause before dumping when |
| | | the vehicle has stopped. |
| MaxEnergizeMin | 10 | Maximum time, in minutes, that the software can |
| | | energize hold or dump signals before causing an |
| | | error. This is the total time one of these signals |
| | | is held active. |
| MaxEnergizeRestMin | 10 | The amount of rest time in minutes after |
| | | MaxEnergizeMin is reached before the software |
| | | allows hold or dump to be set again. |
| MaxRockingFactor | 5 | Used to calculate the number of successive thread |
| | | samples in a row that the vehicle has switched from |
| | | reverse to forward before the state is accepted. Until |
| | | then, the vehicle is deemed to be rocking. The |
| | | number of samples is calculated as follows: |
| | | (200/thread-latency) * rocking-factor. |
| | | So, if rocking factor = 5 and thread latency = 200, |
| | | then the number of samples is 5. Values are truncated |
| | | to integers. For example, if thread latency = |
| | | 150, then (200/150) * 5 = 6.67 truncated to 6. |
| Deceleration Profile | | |
| Distancen | | Distance from dock that this entry starts to have |
| | | effect, in feet. |
| LowSpeedn | | Minimum speed, in mph, for this entry's window. |
| HighSpeedn | | Maximum speed, in mph, for this entry's window. |
| ThreadLatencyn | | Number of ms between samples for this entry. |
| Brake | | |
| HoldPulseWidth | 50 | Used to control hardware hold pulse width if |
| | | HoldIOPort is not −1. Some embodiments may |
| | | not use this variable. |
| DumpPulseWidth | 50 | Used to control hardware dump pulse width if |
| | | DumpIOPOrt is not −1. Some embodiments may |
| | | not use this variable. |
| MaxHoldPulses | 30 | Max number of consecutive hold pulses allowed. |
| | | This counter is reset if state changes out of HOLD. |
| MaxDumpPulses | 30 | Max number of consecutive dump pulses allowed. |
| | | This counter is reset if state changes out of DUMP. |
| StopSpeed | 0 | Defines the speed, in mph, equal to or below which |
| | | the software assumes the vehicle has stopped. |
| DAQ | | |
| DeviceNumber | 1 | The device number connected to the data |
| | | acquisition card. |
| Port | 0 | The DAQ I/O port number. |
| BrakeLine | 1 | The digital output line number of BRAKE APPLY. |
| ReverseLine | 0 | The digital input line number of reverse (direction). |
| HoldLine | 2 | The digital output line number of HOLD. |
| DumpLine | 3 | The digital output line number of DUMP. |
| BrakeHigh | 0 | The value of brake apply when it is active. Inactive |
| | | is the inverse of active. |
| ReverseHigh | 0 | The value of reverse when it is active. |
| HoldHigh | 0 | The value of hold when it is active. |
| DumpHigh | 0 | The value of dump when it is active. |
| HoldIOPort | −1 | The port number (or −1) used to control hold pulse |
| | | width. Some embodiments may not use this |
| | | variable. |
| DumpIOPort | −1 | The port number (or −1) used to control the dump |
| | | pulse width. Some embodiments may not use this |
| | | variable. |

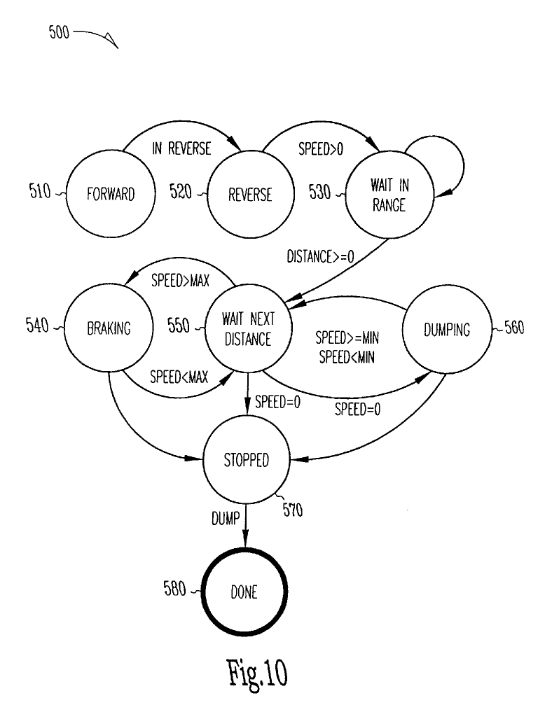

FIG. 9 illustrates computer display 400 operable with one embodiment of the present system. Display 400 provides a user interface and is configured for test and demonstration purposes. In one embodiment, the user interface includes an indicator light that is illuminated when the system is operating and does not include a computer display. In one embodiment, the user interface includes a display configured to show distance, speed, status or hazard conditions. In one embodiment, the user interface includes a data input device to allow entry or adjustment of values such as offset distances or system sensitivity. In one embodiment, the vehicle may have no user accessible controls or display elements for the present system, in which case the system operates independent of the vehicle operator.

The screen of FIG. 9 is divided into run group 410 and test group 425. Run group 410 includes controls and displays to execute an automatic docking procedure. Test group 425 includes controls and displays used to test integrity of selected system components before executing an automatic docking procedure.

READ CONFIG 415, appearing in run group 410, is a user selectable button and allows user modification of the configuration parameters using a text editor. Actuation of READ CONFIG 415 causes the new data to be reloaded without restarting the user interface. In one embodiment, the configuration parameters are stored in a file named AltraBrakeDemo.ini.

START 420, also appearing in run group 410, executes the automatic docking routine. After actuating START 420, the button legend changes to STOP.

RESET 430, within test group 425, is pressed before using any of the other controls in test group 425. Actuation of RESET 430 cause the reset of software running on processor 250, a data acquisition card (DAQ card) and the vehicle mounted sensor.

SET BRAKE APPLY 435 sets the brake apply digital output to an active state.

CLEAR BRAKE APPLY 440 sets the brake apply digital output to an inactive state.

PULSE HOLD 460 pulses the hold line using configuration values. User editable box 465 allows the user to specify how many pulses to perform.

PULSE DUMP 470 pulses the dump line using configuration values. User editable box 475 allows the user to specify how many pulses to perform.

GET DISTANCE 445 cause processor 250 to retrieve distance information from ultrasonic sensor 210 and display the counts and calculated distance using window 445A and 445B, respectively.

GET SPEED COUNTER 450 causes processor 250 to retrieve the number of counts from the speed sensor and calculates speed. Speed is calculated in units of miles per hour or kilometers per hour.

REVERSE 455 is checked if the reverse line is in an active state.

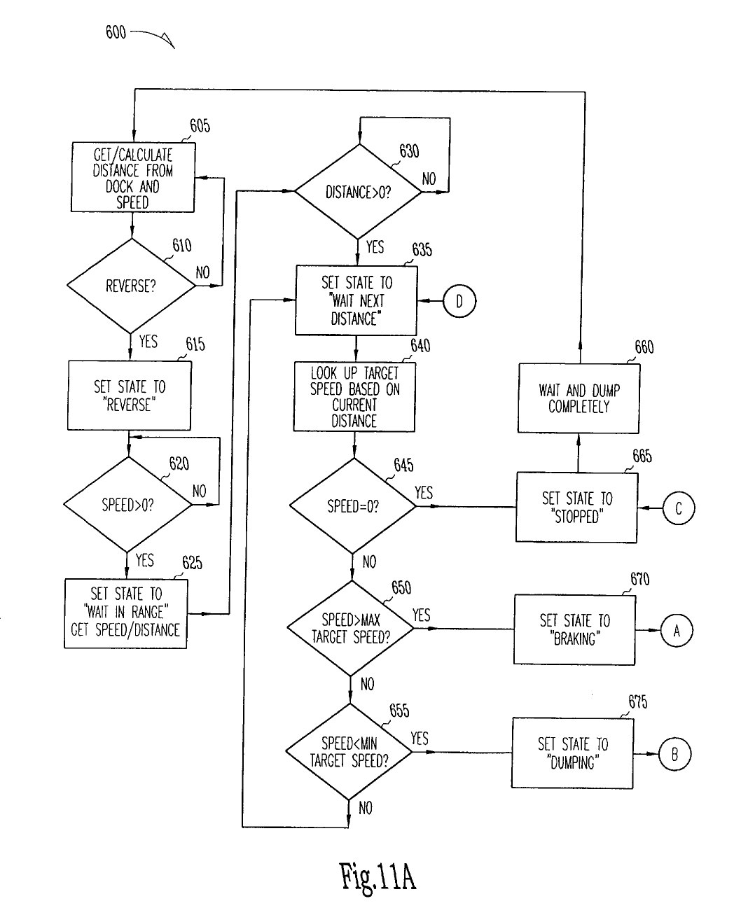

FIG. 10 illustrates state machine 500 operable with the present subject matter. At Forward 510, he vehicle has not yet entered the reverse state. The vehicle may be in neutral, parked or in a forward gear. At this point, the main thread is monitoring the direction line. If reverse is true, the docking thread is created and state is set to reverse.

At Reverse 520, the vehicle is traveling in reverse and moving at a speed greater than stop speed. The vehicle may be traveling in reverse under power from the vehicle engine and transmission, or the vehicle may be traveling in reverse under the force of gravity or momentum.

At Wait In Range 530, the vehicle is in reverse and waiting for the ultrasonic sensor to report a valid distance range.

At Wait Next Distance 550, the vehicle is within the deceleration profile maximum and minimum range and processor 250 is determining which state handles the current speed stored in the deceleration profile for the current distance. The processor retrieves the target speed from the deceleration profile based on the current distance and remains in this state or transitions to either Braking 540, Dumping 560, or Stopped 570.

At Braking 540, the processor is applying the brakes because the current speed exceeds the maximum profile of the deceleration profile for the current distance D. This state pulses HOLD. From this state, the system can transition to Wait next Distance 550 or Stopped 570.

At Dumping 560, the processor is dumping because the current speed is below the maximum profile of the deceleration profile for the current distance D. This state pulses DUMP. From this state, the system can transition to Wait next Distance 550 or Stopped 570.

At Stopped 570, the vehicle has stopped and the processor is waiting to dump to release the brakes.

During the transition between Stopped 570 and Done 580, the vehicle may be rocking fore and aft. Rocking may include holding the vehicle in the Stopped mode for a period of time before transitioning to Done. In one embodiment, the period of time is determined by counting n periods of a clock, where n is an integer.

At Done 580, the stopped state has been achieved and dumping is complete. This exits the docking thread and returns to the main thread to monitor directional state.

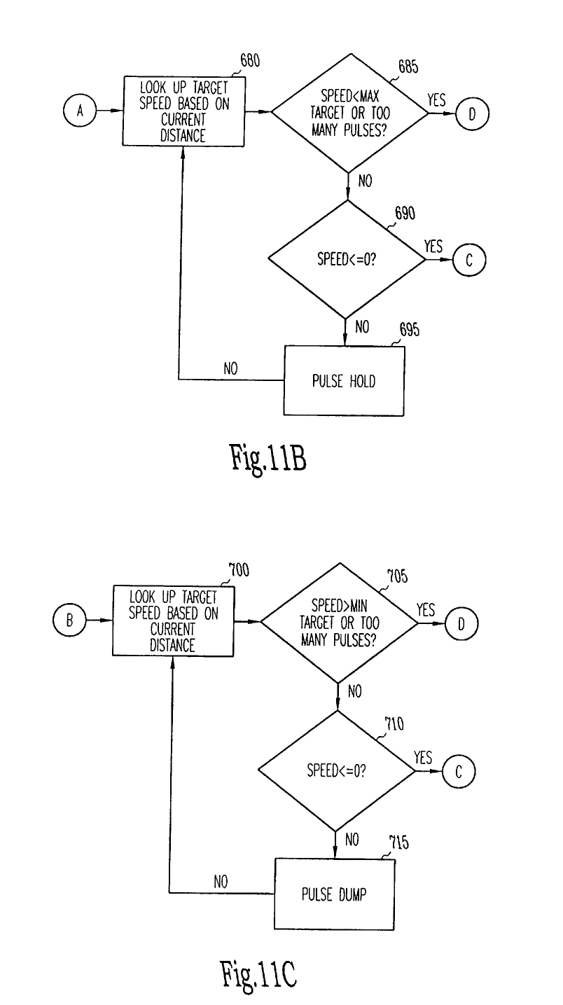

FIGS. 11A, B and C illustrate flow chart 600 operable with the present subject matter. In the embodiment shown, the method begins at 605 with obtaining or calculating the distance D from the dock and the vehicle speed. At 610, an inquiry is raised to determine if the vehicle is in reverse. If not in reverse, then processing returns to 605, otherwise, processing proceeds to 615 where the state is set to “reverse.” At 620, an inquiry is made as to whether the speed is greater than zero. If greater than zero, then processing continues to 625, otherwise, processing loops back to wait until the speed exceeds zero. At 625, the state is set to Wait in Range and the processor obtains the vehicle speed and distance information.

Processing continues at 630, where a query is made to determine if the distance D is greater than zero. Distance D may be zero, in which case, the query results in a negative answer and processing loops back. If yes, then processing proceeds to Wait Next Distance 635 followed by accessing current target distance and speed. At 640, the processor looks up the target speed relative to the measured distance. At 645, the processor asks if the vehicle speed is equal to zero and if yes, then set the state to “stopped 665.” Also, if Stopped, the processor dumps all pressure and waits at 660. If speed is not equal to zero, then processing continues to inquire to determine if vehicle speed exceeds the maximum target speed at 650. If yes, then set the state to “braking 670.” In addition, as denoted by link A, processing continues at 680 (FIG. 11B) which includes looking up the target speed based on the current distance. At 685, a query is presented to determine if speed is less than the maximum target or too many pulses. If the query at 685 results in a positive answer, then processing continues, by following link D, to set state to Wait Next Distance at 635 (FIG. 11A). If the query results in a negative answer, then at 690, the query determines if speed is less than or equal to zero. If yes, then processing continues, following link C, to set state to stopped at 665 (FIG. 11A). If no, then pulse the hold line, at 695, followed by look up target speed based on current distance 680.

Returning to the query at 650, if the answer is negative, then ask if the speed is less than the minimum target speed at 655. If no then processing returns to Wait Next Distance 635. If yes, then set the state to “dumping” 675. Also, after “dumping” 675, following link B, look up target speed based on current distance 700 (FIG. 11C). At 705, a query is presented to determine if speed is greater than the minimum target or too many pulses. If the query at 705 results in a positive answer, then processing continues, by following link D, to set state to Wait Next Distance at 635 (FIG. 11A). If the query results in a negative answer, then at 710, the query determines if speed is less than or equal to zero. If yes, then processing continues, following link C, to set state to stopped at 665 (FIG. 11A). If no, then pulse the dump line, at 715, followed by look up target speed based on current distance 700.

In one embodiment, the algorithm executed by the system is adapted to determine if the vehicle is moving towards the target and adjust the vehicle speed accordingly to achieve the desired deceleration profile.

### Alternative Embodiments

Various alternative embodiments are also contemplated. For example, in one embodiment, vehicle directional information is derived from a series of distance measurements as a function of time and, thus, a separate direction sensor is not used. As another example, one embodiment provides that speed information, and hence, close range distance data, is provided by a digital signal from the vehicle transmission, differential or other wheel sensor.

Other embodiments are also contemplated. For example, in one embodiment, at regular intervals, the processor determines speed and distance remaining to the target. In one embodiment, at regular intervals, the processor determines the current distance based on a calculation using the last known position and the speed profile over the interval time period. In one embodiment, the processor receives distance information at a particular predetermined distance and all subsequent position information is calculated based on time and speed. Other combinations of time, speed and distance are also contemplated.

In one embodiment, the system includes sensors positioned near the front end of a vehicle and is adapted to prevent front end collisions with an obstacle or structure. For example, some rubbish hauling vehicles include loader arms that extend forward from the vehicle. In operation, the vehicle is driven towards a dumpster and the loader arms engage receivers affixed to the sides of the dumpster. In maneuvering the vehicle, the operator is concerned with approaching the dumpster closely but not impacting or damaging the dumpster. An embodiment of the present system can be affixed to the front portion of the vehicle to assist in maneuvering the front of the vehicle into a position near the dumpster.

In one embodiment, the present subject matter operates to achieve a desired deceleration profile to reduce impact damage to the vehicle and nearby structure. The subject matter may be configured to slow the vehicle when traveling in a forward direction or when traveling in a rearward direction.

In one embodiment, the present subject matter operates to preclude forward or rearward motion of the vehicle after the vehicle has been stopped. For example, consider the case where a second vehicle is positioned behind a suitably equipped tractor-trailer after the tractor-trailer has stopped moving. In this case, one embodiment of the present subject matter will lock the vehicle brakes to prevent movement of the tractor-trailer in a direction towards the second vehicle when the vehicle transmission is placed in a reverse gear. If, on the other hand, the transmission is placed in a forward gear, then the present subject matter will release the brakes and allow the vehicle to move forward. In one embodiment, the brakes are applied independent of the actions of the vehicle operator and precludes movement of the vehicle in either a forward or rearward direction, depending on the transmission gear selected by the operator. For another example, consider the case of fuel delivery using a tank trailer. While dispensing fuel into a bulk storage tank, one embodiment of the present system is configured to preclude any movement of the vehicle while the fuel hoses are extended or otherwise not stowed.

In one embodiment, the vehicle speed sensor is coupled to a transmission of the vehicle or to a speedometer of the vehicle. In one embodiment, the vehicle speed sensor is coupled to an engine electronic control module. The vehicle speed sensor may also include a separate Doppler radar sensor or a global positioning satellite (GPS) receiver. In one embodiment, the vehicle speed sensor includes a wheel speed sensor coupled to a trailer wheel or a tractor wheel.

In various embodiments, elements of the present system are coupled by electrical conductors, a data bus or a wireless communication link. For example, a radio transmitter and receiver may be coupled to the range detector and processor, respectively. The range detector may be located near the rear of the vehicle and the processor may be located near the front of the vehicle. In addition, a speed sensor or direction sensor may be located remotely from the processor and coupled by a wireless or wired link.

### CONCLUSION

It is to be understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A system comprising:
a processor coupled to a vehicle;
a brake controller coupled to the processor;
a first range detector coupled to the processor;
wherein the processor executes instructions to operate the brake controller based on a comparison of a deceleration profile with range data from the first range detector and a speed of the vehicle.
